(19) United States
(12) Patent Application Publication
(10) Pub. No.: US 2009/0206106 A1
(43) Pub. Date: Aug. 20, 2009

(54) PURIFIED WATER DISPENSING SYSTEM

(76) Inventors: Alejandro Perez Ordonez, Jalisco (MX); Miriam Julleta Ramirez Ramirez, Jalisco (MX); Jose de Jesus Fernando Ramirez-Gutierrez, Jalisco (MX)

Correspondence Address: KNOBBE MARTENS OLSON & BEAR LLP, 2040 MAIN STREET, FOURTEENTH FLOOR, IRVINE, CA, 92614, US

(21) Appl. No.: 11/815,963

(22) PCT Filed: Feb. 10, 2006
(86) PCT No.: PCT/MX2006/000009

§ 371 Date: Feb. 20, 2009

(30) Foreign Application Priority Data
Feb. 10, 2005 (MX) JL/U/2005/000002

(51) Int. Cl. B67D 5/06; B67D 5/64

(52) U.S. Cl. 222/81; 222/129; 222/185.1

(57) ABSTRACT

The invention relates to a purified water dispensing device comprising a base and a water container which is positioned on top of the base. The base consists of a vertical structure comprising numerous stacked housing sections which are intended to store purified water in special bags. The container includes: a removable valve assembly which is equipped with an element comprising a tip and holes, an upper lid which covers said assembly, and a water-dispensing valve which is disposed in the lower part of the container. In order to fill the container with water, one or more flexible plastic bags containing water are positioned on the tip of the valve assembly, such that each bag is perforated by the tip under its own weight and the water contained therein flows into the container through the above-mentioned holes.

### BACKGROUND OF THE INVENTION

1. Field of the Invention

The purified water dispensing system is designed for dispensing purified water office for domestic use or in office business and industrial sites, and in general any place where an equipment of this nature is required.

2. Prior Art

Currently, a wide variety of equipments or systems for dispensing purified water are known. One of them is the typical water dispensing system which consists of a generally plastic base having an upper opening on which a water container is placed. The water container has its water dispensing orifice, which has been previously opened, faced downwardly so that the base opening is fully covered. The interior cavity of the body of the base element serves as a collecting reservoir that contains the water that gradually is spilled from the water container, said base element further having a valve member through which the water is controllably dispensed into any small containers.

Another known system for dispensing purified water consists of a generally metallic structure in which a water container is inserted. Such metallic structure is adapted to perform a tilting movement so that the dispensing orifice of the water container may be turned downwardly to dispense the liquid in a wished container.

Another known method of dispensing purified water consists in using of a suction device having a cap similar to a cover that fits to the mouth of water container and a pipe element that is introduced into said container to reach its deepest level. The suction device has an element that can be pulled upwardly whereby the liquid in the water container is suctioned to leave through an outlet means in the tube element, adjacent which a container is placed to be filled.

As described above, each one of the conventional systems invariably uses a purified water container made of plastic or glass for dispensing water through any of described means. These systems make necessary to count on an important space in the kitchen for the arrangement of several of said water containers, which becomes most of the cases in a problem because in most of houses the area of the kitchen is rather reduced.

Another disadvantage resulting from the use of common water containers is that they are very heavy to manipulate because of the amount of water contained therein. Therefore, placement of a water container in the water dispensing system requires of an important physical effort. The same problem arise when it is chosen to go directly to a purified water filler service centre because it is required to carry said full water containers from said service centre to the own vehicle and thereafter from this latter when arrived at house, office or business to the area in which they are going to be used for the water supply.

In addition to the above, the fact to reuse water containers, either interchangeable or subject to a deficient cleaning process in water filler service centre, nowadays makes preferable having a different option for the supply of purified water that solves the disadvantages mentioned above. Accordingly, a new more efficient and comfortable water dispensing system is proposed herein.

### SUMMARY OF THE INVENTION

The primary object of the present invention is to propose a new system or equipment for dispensing purified water that consists of a simple and functional structure and concept, which will solve the disadvantages of the dispensing systems traditionally used.

Another object of the invention is to provide a novel water dispensing system that has been designed having in mind specially housewives, pregnant women and disabled people, and old and young people, who will be able to operate said new system without any effort.

Another additional object of the invention is to propose a new ecological concept in dispensing purified water with plastic bags ever used, whereby hygiene and cleanliness of the liquid product contained in them is guaranteed. In addition, said bags are recyclables and due to the contained liquid product they have a ampler use like recycled material.

Another additional object of the invention is to propose a new ecological concept since the use of disposable plastic bags filled with purified water results in water save because the process of washing glass or plastic water containers prior to being refilled is eliminated. In such a cleaning process, up to 4 liters of water per water container to be washed may be wasted because sometimes detergents are commonly used, which are disposed to drainage systems in detriment to environment.

The new proposed water dispensing system is characterized in that it makes unnecessary using plastic or glass containers for containing purified water. In place of said containers, the novel equipment is designed to use purified water, which is contained in food grade, high resistance plastic bags having suitable capacity so that they can be manipulated without any effort. Conveniently, the same water dispensing system provides the necessary area to store said water bags whereby it is not required to have additional space to that end.

The foregoing objects and others that will be evident are fully accomplished by means of a purified water dispensing system comprising, in its preferred embodiment, the following elements:

a) a base furniture including vertical sidewalls parallel each other and a flat top surface that it is connected to the upper end of said sidewalls; equidistant intermediate base elements have been disposed between the sidewalls, said base elements defining storing sections which serve for the storage of plastic bags with water;

b) a generally cylindrical container body providing a recipient to contain a proper amount of purified water; said container body having a valve for dispensing water at the lower section thereof;

c) a valve assembly having a sharp-tipped element placed on the upper opening of the cylindrical container, whereby a plastic water bag is perforated when the user places a water bag on said valve assembly; as a result of this perforation, the water contained in said plastic bag flows into the cylindrical container through orifices provided in said sharp-tipped element; and

d) a lid element shaped in such a manner that it can be placed on the tipped valve assembly to cover this latter.

### BRIEF DESCRIPTION OF THE FIGURES

FIG. 1 is a perspective view, from the left side, of the purified water dispensing system.

FIG. 2 is a frontal view of the purified water dispensing system.

FIG. 3 is partial frontal view of the purified water dispensing system, in which several of its superior elements appear exploded.

FIG. 4 is an inferior perspective view of the valve assembly for drilling plastic bags containing water.

FIG. 5 is a superior perspective view of the valve assembly for drilling plastic bags containing water.

### DETAILED DESCRIPTION OF THE PREFERRED EMBODIMENTS OF THE INVENTION

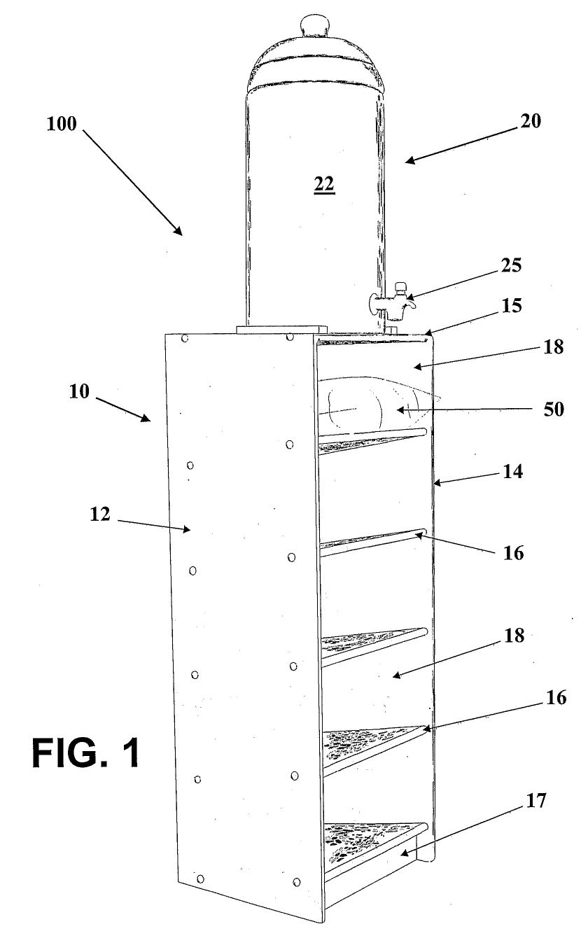

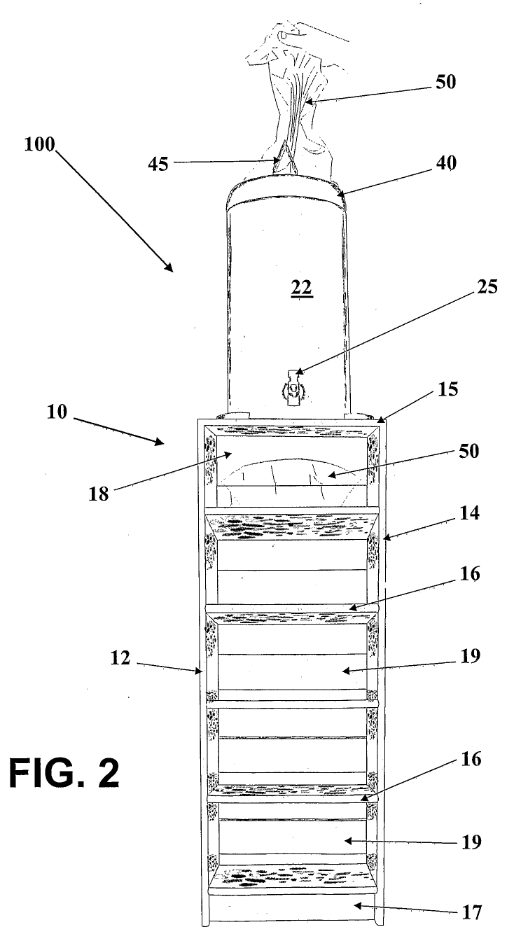

In reference to FIG. 1, the purified water dispensing system (100) consists of a base furniture (10) and a water container (20), of generally cylindrical form. The furniture (10) is conformed by sidewalls (12, 14) that vertically extends and parallel to each other, a horizontal surface (15) that is connected with the superior end of said sidewalls (12, 14) and a base section (17) placed in the inferior end of each sidewall (12, 14). Additionally, the furniture (10) includes intermediate base elements (16) distributed uniformly between the sidewalls (12, 14) so that they form jointly compartments (18) for the lodging of multiple plastic bags (50) with water. Preferably, strips (19) are disposed at the rear section of the furniture (10) which extend from a sidewall to the other, said strips (19) serving like containment elements of the plastic bags stored in the compartments (18).

In order to maintain the water bags (50) in stored position within the compartments (18), it has been anticipated that each intermediate base element (16) is placed with an inclination so that its front end remains in a plane slightly higher than the rear end of each intermediate base element (16). This inclination will make sure that the plastic water bags (50) stored in the furniture compartments (18) do not slide forwardly and fall of the furniture.

On the other hand, the cylindrical container (20) is constituted by three main elements that become engaged to form a single assembly: a container body (22) having preferably cylindrical shape, the upper end of said body being opened, a valve assembly (40) having a sharp-tipped element (45) the function of which will be described hereupon, and a lid element (35) superposed on said assembly (40) so that said lid covers entirely the tipped element (45).

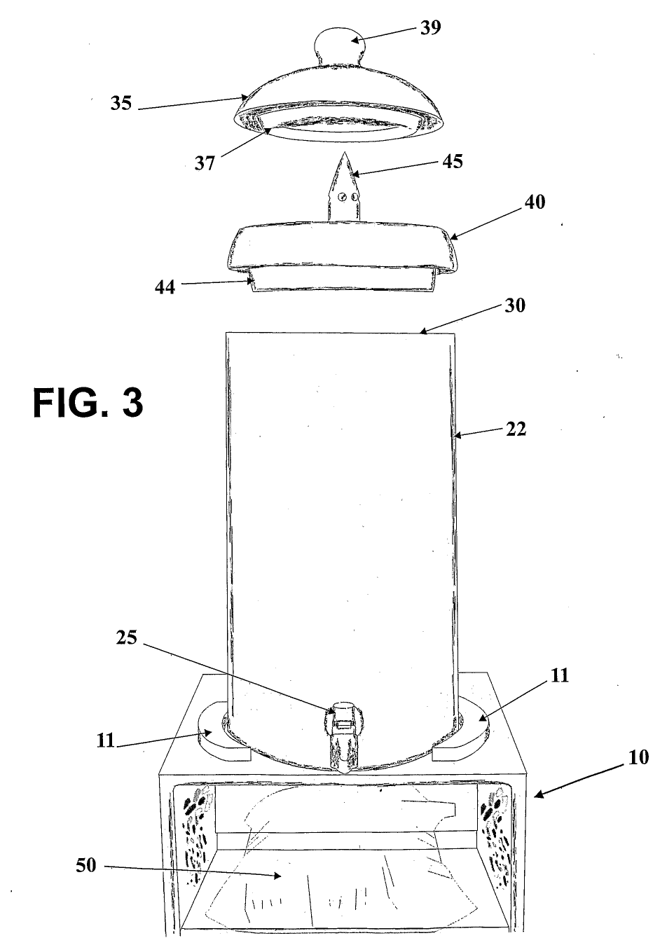

As observed in FIG. 3, the valve assembly (40) consists in an essentially circular member including a first annular section (42) the diameter of which is equivalent to the external diameter of the superior edge (30) of the cylindrical container body (22) and a second annular section (44) extending downwardly from the bottom of the first section (42), which engages the inner edge of the superior opening (30) of the cylindrical body (22). In turn, the lid element (35) is preferably shaped like a hemispheric member including a lower annular lip (37) having a diameter to fit to the recessed annular section (46) of the valve assembly (40) that surrounds to the tipped element (45). The upper end of the lid element (35) consist of a protuberance (39), generally spherical, although not necessarily, which serves to grasp said lid (35) to remove it from or placing it on the valve assembly (40) of the system. The hollow interior of said protuberance (39) serves in addition to lodge the sharp end of the tipped element (45).

The tipped element (45) of the valve assembly (40) consists of a generally cylindrical protruding member, the superior end of which finishes in a sharp tip. Also, said element (45) has orifices (48) circumferentially arranged for the passage of purified water to the interior of the body (22) of the cylindrical container (20) when a plastic water bag (50) being placed on the tipped element (45) of said valve assembly (40) is perforated by insertion of element (45) in said water bag.

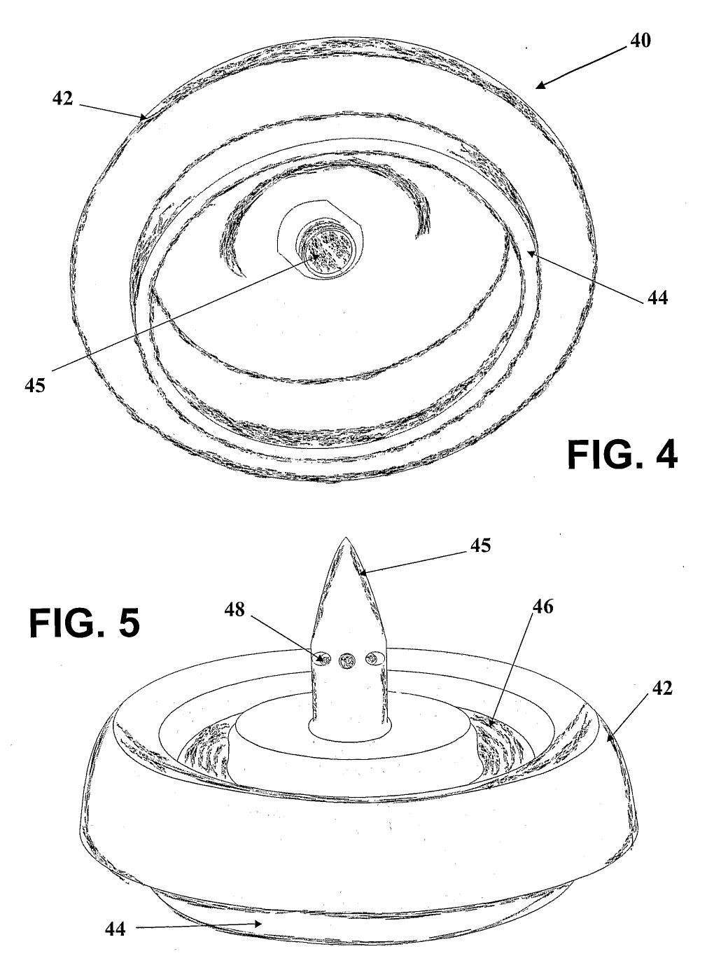

With reference to FIGS. 4 and 5, the tipped element (45) of the valve assembly is positioned to the center of the body of the valve assembly (40) passing through an orifice in the valve assembly body (40). The fastening of said tipped element (45) to said body is by means of threaded connection (FIG. 4). Because both of these elements are made of plastic material no corrosion problem will result. Nevertheless, it will be understood that any other suitable material can be used for the manufacture of the sharp tipped element of the valve and similarly any other suitable means to fasten said tipped element to the valve assembly can be used.

For dispensing of the water, the cylindrical container (20) has integrated a conventional dispensing valve (25) disposed in the lower part of same. The operation of said dispensing valve will not be described in detail because it is well known.

As observed in FIG. 3, furniture (10) comprises retention means (16) in its superior surface (15), which limit the lateral sliding of the cylindrical container (20), said retention means being shaped as semicircular ribs. It will be obvious that for the same purpose different means that meet the same function can be implemented without departing from the inventive concept previously described.

As described before, the new purified water system offers a viable alternative for substituting traditional plastic or glass water container by the use of plastic bags with purified water, the handling of them being safer and comfortable. At the same time, the new water dispensing system constitutes at sight an aesthetic and pleasant model in comparison with the current systems using the mentioned water container.

Additionally, the water dispensing system of the present invention has the advantage that if the plastic water bags ended off, said system can continue working by simply refilling up the receiving container with purified water supplied from another source. It would be only required to remove the lid element and the drilling element and valve assembly to spill the water through the upper opening of the container.

In accordance with the foregoing, it will be evident that this system can be useful to be used not only as conceived, that is, with the purified water supplied by plastic bags but also by refilling the receiver container with purified water by any other means, if necessary.

Although this invention has been described in the context of a specific preferred embodiment, it will be evident for a person having ordinary skill in the art that the scope of the present invention extends beyond the embodiment specifically described to other alternative embodiments and/or uses of the invention that are obvious and resulting from the same. In addition, although the invention has been shown and described in detail, it will be clearly obvious for specialists in the art that other modifications or changes will fall within the scope of the present invention in the light of the preceding description. Therefore, it is assumed that several combinations can result from the characteristics and aspects of the described embodiment that would fall doubtless within the scope of the invention. It will be understood that several characteristics and aspects of the described embodiment can be combined with others or be replaced by others to conform alternative ways of accomplishment of the invention described hereinbefore. Thus, it is intended that the scope of the present invention should not be limited by the particular embodiment described above, but rather said scope should be defined by a reasonable interpretation of the following claims.

1. A purified water dispensing system, comprising:
a) a base furniture having several compartments for the storage of a plurality of plastic bags containing purified water;
b) a container consisting in a reservoir to contain a certain amount of purified water; said container being placed onto said base furniture and including a superior opening and a dispensing valve in its lower part for dispensing water;
c) a valve assembly placed on the superior opening of the container and including a tipped element by means of which a plastic water bag is perforated when said bag is placed on said valve assembly; the tipped element has orifices through which the water contained in said plastic water bags is spilled towards the interior of the container as a result of said perforation; and
d) a lid element to be placed on the tipped valve assembly to cover the latter.

2. The system of claim 1, wherein said base furniture comprises sidewalls parallel to each other, a superior surface joined to the superior end of the sidewalls, and a base section in the lower part of said furniture.

3. The system of claim 1, wherein the base furniture also includes a plurality of strips extending from a sidewall to the other in the rear part to the furniture.

4. The system of claim 1, in which the furniture includes intermediate base elements distributed uniformly throughout the sidewalls to define compartments where the water bags are stored.

5. The system of claim 1, in which said intermediate base elements are arranged in such a manner that they are inclined, the front end of said intermediate elements remaining in a plane higher than their rear end to assure that the water bags do not fall from the furniture.

6. The system of claim 1, wherein said container is preferably cylindrical.

7. The system of claim 1, in which the water bag is perforated when it is placed onto the tipped valve assembly.

8. The system of claim 1, in which the base furniture also includes elements to avoid the horizontal sliding of the reservoir container.

9. The system of claim 1, in which the tipped element of said valve assembly is made of plastic or any other non corrosive material.

10. The system of claim 1, in which said valve assembly has an inferior annular section for engagement with the superior opening of the reservoir container.

11. The system of claim 1, in which said valve assembly includes a recessed annular section to contain spilled water.

12. The system of claim 1, in which said tipped element of said valve assembly is a hollow piece.

13. The system of claim 1, in which said lid element has a substantially spherical protuberance that serves as a handle, the hollow interior of said protuberance providing a space to lodge the sharp end of said tipped element of the valve assembly.

14. The system of claim 1, in which said lid element has an inferior annular lip engaging with the recessed annular section of said valve assembly for its positioning.

15. A purified water dispenser, comprising:
a) a generally cylindrical container providing a reservoir to contain a certain amount of purified water; said container has a superior opening and a dispensing valve in the inferior part for dispensing water; and
b) a generally annular valve assembly to be placed onto the superior opening of said container and including a tipped element having orifices; said tipped element being adapted to perforate a plastic bag with purified water when said bag is placed on said valve assembly, whereby the water contained in bag is spilled towards the interior of said cylindrical container through said orifices.

16. The dispenser of claim 15, further including a lid element that is placed on said valve assembly to cover it.

17. The dispenser of claim 15, wherein said valve assembly has means to become safely engaged with said cylindrical container.

18. The dispenser of claim 15, in which said valve assembly includes a recessed annular section to contain any water spills.

19. The dispenser of claim 16, in which said lid element has an inferior annular lip for engagement with said recessed annular section of the valve assembly.

20. The dispenser of claim 16, in which said lid element has a substantially spherical protuberance that serves as a handle, the hollow interior of said protuberance serving to lodge the sharp end of the tipped element of said valve assembly.

21. A purified water dispensing system, comprising a furniture conformed by sidewalls extending vertically and parallel to each other, a horizontal surface for engagement with the superior end of said sidewalls, a base section arranged in the inferior end of said sidewalls; a cylindrical reservoir for containing water which has its open superior end and having a water dispensing valve located in the inferior part of the body of said reservoir container, said cylindrical container is placed onto the horizontal surface of said furniture, said dispensing system is characterized by comprising:
e) a valve assembly conformed by a first annular section having a diameter equivalent to the external diameter of the open superior end of said cylindrical container; a second annular section extending vertically downwardly from the inferior face of the first annular section for engagement with the inner edge of the open superior end of said cylindrical container; a recessed annular section extending inwardly towards the center of said first annular section; and a hollow cylindrical projection having a tipped superior end for the perforation of plastic bags with water, said tipped end extending vertically upwardly from the first annular section and having a plurality of orifices provided circumferentially on its body to allow the passage of water to the interior of the cylindrical container; and
f) an hemispheric lid having an annular lip extending vertically downwardly from the inferior face of said lid engagement with the recessed annular section of said valve assembly for its positioning.

22. The system of claim 21, characterized in that said furniture includes intermediate base elements distributed uniformly throughout the sidewalls to define jointly compartments.

23. The system of claim 21, characterized in that said furniture further includes strips extending from a sidewall to the other, on the rear part of the furniture, said strips serving for the containment of the objects to be placed in the compartments.

24. The system of claim 21, characterized in that said intermediate base elements are placed in such a manner that they are inclined, the front end of which remains in a plane higher than that of the rear end to assure that the objects placed in the compartments do not fall of the furniture.

25. The system of claim 21, further characterized in that said furniture includes supports of retention in the superior surface horizontal which avoid the lateral displacement of the reservoir container that is placed on said furniture.

26. The system of claim 21, characterized in that the tipped projection of the valve assembly is made of plastic or any other non corrosive material.

27. The system of claim 21, characterized in that the recessed annular section is further adapted to contain spilled water.

28. The system of claim 21, characterized in that said lid element has a substantially spherical protuberance that serves as a handle and the hollow interior of said protuberance defines a space to lodge the tipped end of the cylindrical projection.

29. The system of claim 21, characterized in that said cylindrical projection is disposed in the center of the valve assembly, said projection passing through said valve assembly and being fastened to it by any proper means.
